(19) United States
(12) Patent Application Publication
(10) Pub. No.: US 2025/0079963 A1
(43) Pub. Date: Mar. 6, 2025

(54) VIBRATION MOTOR

(71) Applicant: AAC Microtech (Changzhou) Co., Ltd., Changzhou (CN)

(72) Inventors: Weibo Chen, Changzhou (CN); Xiaorong Zhou, Changzhou (CN); Ziyang Zhang, Changzhou (CN); Keyang Wang, Changzhou (CN)

(21) Appl. No.: 18/540,934

(22) Filed: Dec. 15, 2023

Related U.S. Application Data
(63) Continuation of application No. PCT/CN2023/116825, filed on Sep. 4, 2023.

(51) Int. Cl. H02K 33/18

(52) U.S. Cl. CPC H02K 33/18

(57) ABSTRACT

The present application provides a vibration motor, including a spring holder, a vibrator connected to the spring holder, and a casing. The spring holder includes a fixing portion connected to the vibrator, an elastic arm extending from the fixing portion, and an engagement portion. The fixing portion is provided with a first surface connected to the vibrator, a second surface, and a first side surface. The second surface is provided with a first welding piece, and the first welding piece is provided with a second side surface arranged opposite to the first side surface, and the second side is spaced apart from the vibrator. In the above-mentioned structure, the first welding piece does not interfere with the abutting fit between the fixing portion and the vibrator, thereby improving the performance and yield of the vibration motor.

### CROSS-REFERENCE TO RELATED APPLICATIONS

This application is a continuation of International Application No. PCT/CN2023/116825, filed Sep. 4, 2023, the entire contents of which are incorporated herein by reference.

### TECHNICAL FIELD

The present application relates to the technical field of motors, in particular to a vibration motor.

### BACKGROUND

With the development of science and technology as well as the progress of society, portable electronic products such as smartphones, handheld game consoles, navigation devices, or handheld multimedia entertainment devices are widely used in people's daily lives. In certain scenarios of these electronic products, such as incoming call alerts, message alerts, navigation prompts, and haptic feedback in gaming consoles, are generally realized by the vibration motor.

The vibration motor in the related art includes a spring holder and a vibrator connected to the spring holder. The spring holder includes a fixing portion connected to the vibrator, and an outer surface of the fixing portion is provided with a welding piece for welding and fixing the vibrator and the fixing portion. In order to ensure the reliability of the vibrator in the vibration process, it is necessary to abut a side of the fixing portion against the vibrator. However, the welding piece in the related art is flush with an edge of the fixing portion, and the welding piece and the side of the fixing portion are abutted against the vibrator, so the positional accuracy of the welding piece and the fixing portion when welding is very high, and the position of the welding piece often results in a poor fit between the fixing portion and the vibrator, which affects the performance and the yield of the product.

Therefore, it is necessary to provide a product to solve the above-mentioned problem.

### SUMMARY

An object of the present application is to provide a vibration motor to eliminate the effect of welding pieces on product performance and yield, and to improve the performance and yield of the vibration motor.

In order to achieve the above object, the present application provides a vibration motor, comprising:
a spring holder;
a vibrator connected to the spring holder; and
a casing configured to accommodate the spring holder and the vibrator;
wherein the spring holder comprises a fixing portion connected to the vibrator, an elastic arm extending from the fixing portion, and an engagement portion extending from the elastic arm and connected to the casing; the fixing portion is provided with a first surface connected to the vibrator, a second surface opposite to the first surface, and a first side surface connecting the first surface to the second surface and abutted against the vibrator;
wherein the second surface is provided with a first welding piece, which is provided with a second side surface arranged opposite to the first side surface; and the second side is spaced apart from the vibrator.

In one embodiment, the engagement portion is provided with a third surface opposite to the vibrator, and the third surface is provided with a second welding piece.

In one embodiment, the vibrator is provided with a damping member between the vibrator and the elastic arm; the vibrator is provided with a slot, and the damping member is at least partially embedded in the slot.

In one embodiment, the vibrator comprises a mass block having an accommodating space and a magnetic steel fixed in the accommodating space; the casing comprises a top cover and a bottom plate closing the top cover; the vibration motor further comprises a stator configured to driver the vibrator in motion and a circuit board configured to feed the stator, wherein the stator and the circuit board are fixed to the bottom plate.

In one embodiment, the accommodating space is provided with a recess configured to accommodate the magnetic steel; the magnetic steel is fixed to the recess, and a magnet-conducting plate is sandwiched between the magnetic steel and the mass block.

In one embodiment, the stator comprises a magnet-conducting structure fixed to the bottom plate and a coil wrapped around the magnet-conducting structure, and the stator is at least partially accommodated in the accommodating space.

In one embodiment, the vibration motor further comprises a limit block fixed to the bottom plate.

In the vibration motor of the present application, the fixing portion of the spring holder is provided with a first surface connected to the vibrator, a second surface opposite to the first surface, and a first side surface connecting the first surface to the second surface and abutted against the vibrator. The second surface is provided with a first welding piece, and the first welding piece is provided with a second side surface arranged opposite to the first side surface, and the second side is spaced apart from the vibrator. In the above-mentioned structure, the first welding piece does not interfere with the abutting fit between the fixing portion and the vibrator, so as to reduce the positional accuracy requirements when welding the spring holder to the first welding piece and ensure the abutting fit between the spring holder and the vibrator, thereby eliminating the influence of the welding piece on the performance and yield of the product, and improving the performance and yield of the vibration motor.

### BRIEF DESCRIPTION OF THE DRAWINGS

In order to illustrate the technical solutions in the embodiments of the present application more clearly, the accompanying drawings to be used in the description of the embodiments will be briefly introduced below. Obviously, the accompanying drawings in the following description are only some embodiments of the present application, and for those of ordinary skill in the field, other accompanying drawings may be obtained based on these drawings without creative labor.

FIG. 1 shows a three-dimensional structural diagram of a vibration motor according to an embodiment of the present application.

FIG. 2 shows a three-dimensional exploded view of the vibration motor according to an embodiment of the present application.

FIG. 3 shows a sectional view along the direction of line A-A in FIG. 1.

FIG. 4 shows an enlarged view of B in FIG. 3.

### DETAILED DESCRIPTION OF THE EMBODIMENTS

The technical solutions in the embodiments of the present application will be described clearly and completely in the following in conjunction with the accompanying drawings in the embodiments of the present application. Obviously, the described embodiments are only a part of the embodiments of the present application and not all of the embodiments. Based on the embodiments in the present application, all other embodiments obtained by those of ordinary skill in the art without making creative labor are within the protection scope of the present application.

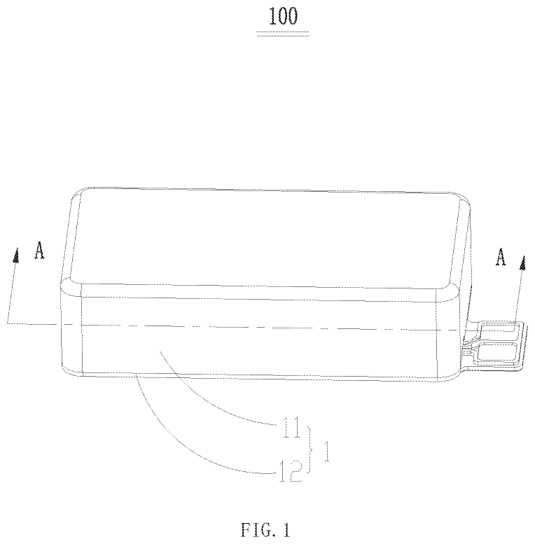

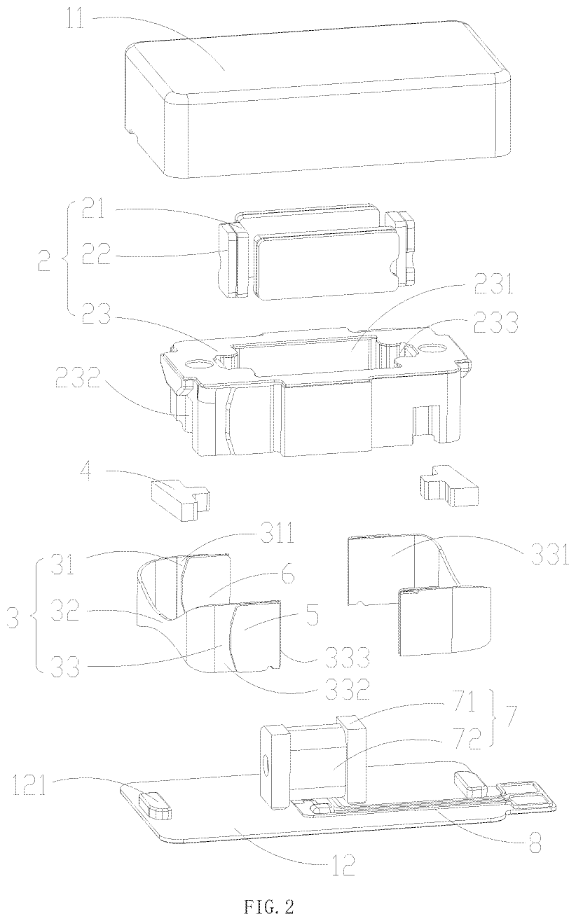

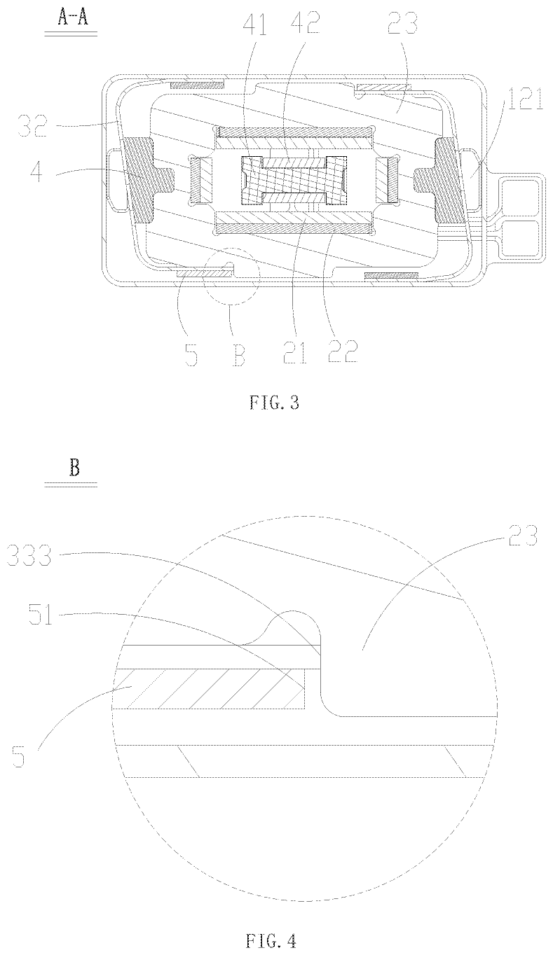

Referring to FIGS. 1-4, the present application provides a vibration motor 100, including a casing 1, a vibrator 2 accommodated in the casing, and a spring holder 3. One end of the spring holder 3 is connected to the casing 1, and the other end thereof is connected to the vibrator 2 and suspends the vibrator 2 in the casing 1. The spring holder 3 is arranged on two sides of the vibrator 2 along a vibration direction of the vibrator 2.

The casing 1 consists of a top cover 11 and a bottom plate 12 that closes the top cover 11. A stator 7 and a circuit board 8 configured to feed the stator 7 are fixed to the bottom plate 12. The stator 7 generates a magnetic field when it is energized, and it reacts on the vibrator 2 under the action of the magnetic field to cause the vibrator 2 to move back and forth under the support of the spring bracket 3.

The vibrator 2 includes a mass block 23 and a magnetic steel 21. The mass block 23 is provided with an accommodating space 231, and the accommodating space 231 is provided with a recess 233 for accommodating the magnetic steel 21. A magnet-conducting plate 22 is sandwiched between the magnetic steel 21 and the mass block 23.

The spring holder 3 includes a fixing portion 33 connected to the vibrator 2, an elastic arm 32 extending from the fixing portion 33, and an engagement portion 31 extending from the elastic arm 32 and connected to the casing 1.

The fixing portion 33 is provided with a first surface 331 connected to the vibrator 2, a second surface 332 opposite to the first surface 331, and a first side surface 333 connecting the first surface 331 to the second surface 332 and abutted against the vibrator 2. The second surface 332 is provided with a first welding piece 5, and the first welding piece 5 is provided with a second side surface 51 arranged opposite to the first side surface 333. As shown in FIG. 4, the second side surface 51 is spaced apart from the vibrator 2, so that the first welding piece 5 does not interfere with the abutting fit of the fixing portion 33 and the vibrator 2, so as to reduce the positional accuracy requirements when welding the spring holder 3 to the first welding piece 5 and ensure the abutting fit between the spring holder 3 and the vibrator 2, thereby eliminating the influence of the welding piece on the performance and yield of the product, and improving the performance and yield of the vibration motor.

A damping member 4 is provided between the vibrator 2 and the elastic arm 32, and the mass block 23 is provided with a slot 232. The damping member 4 is at least partially embedded in the slot 232, so that during the repeated movement of the vibrator 2, the presence of the damping member 4 can make the movement of the vibrator 2 softer and more stable.

The engagement portion 31 is provided with a third surface 311 opposite to the vibrator 2. The third surface 311 is provided with a second welding piece 6, and the engagement portion 31 is connected to the casing 1 through the second welding piece 6.

The stator 7 includes a magnet-conducting structure 71 fixed to the bottom plate 12. The magnet-conducting structure 71 is in the shape of an “I” along the direction of line A-A in the sectional view. The coil 72 is wrapped around a narrower portion of the magnet-conducting structure 71, and the stator 7 is accommodated in the accommodating space 231.

The vibration motor 100 further includes a limit block 121 fixed to the bottom plate 12. The limit block 121 is configured to limit the displacement of the vibrator 2.

Compared with the related art, in the vibration motor of the present application, the first welding piece does not interfere with the abutting fit between the fixing portion and the vibrator, so as to reduce the positional accuracy requirements when welding the spring holder to the first welding piece and ensure the abutting fit between the spring holder and the vibrator, thereby eliminating the influence of the welding piece on the performance and yield of the product, and improving the performance and yield of the vibration motor.

Described above are only some embodiments of the present application, and it should be noted herein that improvements may be made by those of ordinary skill in the art without departing from the inventive conception of the present application, but all of these fall within the protection scope of the present application.

What is claimed is:

1. A vibration motor, comprising:
a spring holder;
a vibrator connected to the spring holder; and
a casing configured to accommodate the spring holder and the vibrator;
wherein the spring holder comprises a fixing portion connected to the vibrator, an elastic arm extending from the fixing portion, and an engagement portion extending from the elastic arm and connected to the casing; the fixing portion is provided with a first surface connected to the vibrator, a second surface opposite to the first surface, and a first side surface connecting the first surface to the second surface and abutted against the vibrator;
wherein the second surface is provided with a first welding piece, which is provided with a second side surface arranged opposite to the first side surface; and the second side is spaced apart from the vibrator.

2. The vibration motor of claim 1, wherein the engagement portion is provided with a third surface opposite to the vibrator, and the third surface is provided with a second welding piece.

3. The vibration motor of claim 1, wherein a damping member is provided between the vibrator and the elastic arm; the vibrator is provided with a slot, and the damping member is at least partially embedded in the slot.

4. The vibration motor of claim 1, wherein the vibrator comprises a mass block having an accommodating space and a magnetic steel fixed in the accommodating space; the casing comprises a top cover and a bottom plate closing the top cover; the vibration motor further comprises a stator configured to driver the vibrator in motion and a circuit board configured to feed the stator, wherein the stator and the circuit board are fixed to the bottom plate.

5. The vibration motor of claim 4, wherein the accommodating space is provided with a recess configured to accommodate the magnetic steel; the magnetic steel is fixed to the recess, and a magnet-conducting plate is sandwiched between the magnetic steel and the mass block.

6. The vibration motor of claim 4, wherein the stator comprises a magnet-conducting structure fixed to the bottom plate and a coil wrapped around the magnet-conducting structure, and the stator is at least partially accommodated in the accommodating space.

7. The vibration motor of claim 4, further comprising a limit block fixed to the bottom plate.
